(19) United States
(12) Patent Application Publication
(10) Pub. No.: US 2025/0284819 A1
(43) Pub. Date: Sep. 11, 2025

(54) SYSTEMS AND METHODS FOR EVALUATING GENERATIVE ARTIFICIAL INTELLIGENCE (AI) SOLUTIONS

(71) Applicant: State Farm Mutual Automobile Insurance Company, Bloomington, IL (US)

(72) Inventor: Jay W. Schmitt, Germantown Hills, IL (US)

(21) Appl. No.: 19/046,260

(22) Filed: Feb. 5, 2025

Related U.S. Application Data
(60) Provisional application No. 63/562,400, filed on Mar. 7, 2024.

(51) Int. Cl. G06F 21/57

(52) U.S. Cl. CPC G06F 21/577; G06F 2221/033

(57) ABSTRACT

A computing device including at least one memory and at least one processor in communication with the at least one memory is disclosed. The at least one processor is programmed to: (i) prompt a user to input a plurality of components of a proposed generative artificial intelligence (GEN AI) solution by causing to be displayed on a user computing device a template requesting the plurality of components; (ii) in response to receiving the plurality of components, evaluate the proposed GEN AI solution by outputting a use score, wherein the use score represents an overall value of deploying the GEN AI solution including a likelihood of a data compromising event occurring as a result of the deployment; and (iii) output a priority report including a comparison of the use score for the current proposed GEN AI solution to other GEN AI solutions being considered.

### CROSS-REFERENCE TO RELATED APPLICATIONS

This application claims priority to U.S. Provisional Patent Application No. 63/562,400, filed Mar. 7, 2024, entitled “SYSTEMS and METHODS FOR EVALUATING GENERATIVE ARTIFICIAL INTELLIGENCE (AI) SOLUTIONS,” the entire content of which is hereby incorporated herein by reference in its entirety.

### FIELD OF THE DISCLOSURE

The present disclosure generally relates to generative artificial intelligence (AI) usage, and more particularly, to a network-based system and method for objectively evaluating generative AI solutions for an overall value proposition including data security aspects.

### BACKGROUND

Artificial intelligence (AI), and, in particular, ChatGPT's popularity has made significant contributions in the public adoption of AI (or generally known as generative AI) and widespread usage almost everywhere. Large language models (LLMs) and foundation models power generative AI to perform various tasks by enabling a computing device to learn context, infer content, and be creative to generate content, answer questions, etc. based upon keywords or prompts provided by a user of generative AI. While being useful in saving time to perform various tasks, there are certain risks associated with the use of generative AI. Since generative AI tools require its users to provide prompts or other input data, which may include, or may be based upon, confidential data or a trade secret of an organization, in order to produce an output using the generative AI tools, there are certain risks associated with each particular AI project or tool. In addition, data required to build a model to be used as part of a generative AI tool may also require confidential information such as medical data, financial data, or personally identifiable data. Depending upon the parties that will use these models and how the models will be used, the use of the models may expose the creator of the models and the confidential data to certain risks.

Accordingly, there exists a need for a method and/or system programmed to objectively evaluate generative AI solutions and/or usage that includes determining the value resulting from the tool but also the data security risks associated therewith. The need also exists for a method and system that is configured to identify confidential information or personal information that may be used in an AI tool. This evaluation may include (i) evaluating the type of data used as an input to the generative AI model and/or the data used to build the generative AI model, (ii) generating an output score for different use cases to better understand and measure data security risks for each use case, and (iii) output recommendations on how to reduce the likelihood of a data compromise or breach in these uses cases.

### BRIEF SUMMARY

The present embodiments may relate to, inter alia, systems and methods that objectively evaluate multiple generative AI (“GEN AI”) use cases or solutions, and the data security associated therewith. The systems and methods may determine an output score that objectively measures the overall value of the solution and the risk associated with each use case, wherein the output score is directly related to the type of data used as an input for the model, the type of data used to build the model, the parties who may access the model, and/or the location of the computer hardware in applying the model. The systems and methods may also help in identifying confidential data that may be used in the GEN AI tool. The use of GEN AI is complex and, in many cases, opaque in nature. The GEN AI evaluation system described herein is configured to address this complexity and opaqueness by objectively measuring the overall value and risks associated with using GEN AI solutions in multiple different use cases. As described herein, when a business unit within a company wants to have a GEN AI solution developed or brought in through a third-party, the business unit typically will submit a use case. The GEN AI evaluation system may then be used to objectively evaluate that use case by inputting the use case data for evaluating the solution components, and outputting a score that measures the overall value and risk associated with that use case. The business unit can then better evaluate whether to move forward with the GEN AI solution and/or prioritize all of the GEN AI solutions it may be considering.

As discussed above, the plurality of components to be evaluated by the GEN AI evaluation system may be dynamically determined based at least in part upon prompts provided by a user. The user may provide inputs corresponding to each component of the plurality of components, for example, using several objective multiple-choice questions. Based upon the user inputs and the plurality of components of the project or tool (or use case, in general), a value (or output score) may be calculated or determined to quantify the level of return in deploying the tool including the associated risk in deploying and using the tool. In other words, the GEN AI evaluation system described herein is configured to objectively and with repeatability quantify the overall value and risks associated with one or more GEN AI use cases. Thus, the system is configured to create an objective process around what is generally a subjective process. While embodiments are described generally in the context of generative AI, however, the scope of the embodiments is not limited to generative AI.

In one aspect, a computer system for objective evaluation and prioritization of a GEN AI solution may be provided. The computer system may include a computing device, one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the computer system may include at least one memory and at least one processor in communication with the at least one memory. The at least one processor may be programmed to: (i) prompt a user to input a plurality of components of a proposed generative artificial intelligence (GEN AI) solution by causing to be displayed on a user computing device a template requesting the plurality of components; (ii) in response to receiving the plurality of components, evaluate the proposed GEN AI solution by outputting a use score, wherein the use score represents an overall value of deploying the GEN AI solution including a likelihood of a data compromising event occurring as a result of the deployment; and (iii) output a priority report including a comparison of the use score for the current proposed GEN AI solution to other GEN AI solutions being considered. The computer system may include additional, less, or alternate functionality, including that discussed elsewhere herein.

In another aspect, a computer-implemented method for objective evaluation and prioritization of a GEN AI solution may be provided. The computer-implemented method may be implemented using a computing device, one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the computer-implemented method may be performed by a computer device including at least one processor in communication with at least one memory device. The method may include: (i) prompting a user to input a plurality of components of a proposed generative artificial intelligence (GEN AI) solution by causing to be displayed on a user computing device a template requesting the plurality of components; (ii) in response to receiving the plurality of components, evaluating the proposed GEN AI solution by outputting a use score, wherein the use score represents an overall value of deploying the GEN AI solution including a likelihood of a data compromising event occurring as a result of the deployment; and (iii) outputting a priority report including a comparison of the use score for the current proposed GEN AI solution to other GEN AI solutions being considered. The computer-implemented method may include additional, less, or alternate actions, including those discussed elsewhere herein.

In yet another aspect, at least one non-transitory computer-readable storage medium (CRM) with instructions stored thereon for objective evaluation and prioritization of a GEN AI solution is disclosed. The non-transitory computer-readable storage medium may be executed using a computing device, one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the instructions, when executed by at least one processor, cause the at least one processor to: (i) prompt a user to input a plurality of components of a proposed generative artificial intelligence (GEN AI) solution by causing to be displayed on a user computing device a template requesting the plurality of components; (ii) in response to receiving the plurality of components, evaluate the proposed GEN AI solution by outputting a use score, wherein the use score represents an overall value of deploying the GEN AI solution including a likelihood of a data compromising event occurring as a result of the deployment; and (iii) output a priority report including a comparison of the use score for the current proposed GEN AI solution to other GEN AI solutions being considered. The at least one non-transitory CRM may include additional, less, or alternate actions, including those discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed herein. However, it should be understood that the present embodiments are not limited to the precise arrangements and/or are instrumentalities shown herein.

FIG. 1 depicts an exemplary flow diagram showing the process of objectively evaluating and prioritizing a GEN AI solution including performing a risk stratification and prioritization of such GEN AI use cases, in accordance with one embodiment of the present disclosure.

FIG. 2 depicts an exemplary configuration of a user device or user equipment for use with the process shown in FIG. 1, in accordance with one embodiment of the present disclosure.

FIG. 3 depicts an exemplary configuration of an application server for use with the process shown in FIG. 1, in accordance with one embodiment of the present disclosure.

FIG. 4 depicts a flow-chart of exemplary computer-implemented method operations for objectively evaluating and prioritizing a GEN AI solution including risk stratification and prioritization, in accordance with one embodiment of the present disclosure.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, network-based systems and methods that objectively evaluate one or more GEN AI solutions (“GEN AI evaluation system” or “evaluation system”) by considering a plurality of solution components that are part of each of the GEN AI solutions, and generate an output score for comparing the different GEN AI solutions and prioritizing the GEN AI solutions for deployment. The output score is generated based at least in part upon user inputs for a plurality of use case components (also referenced herein as a plurality of solution components). Accordingly, when the use cases are reviewed based upon a respective output score assigned to each of the GEN AI solutions, as described herein, the evaluators are better able to objectively decide whether to move forward with the GEN AI solution or to not move forward with it because of concerns relating to any of the use case components being evaluated. In other words, embodiments described in the present disclosure may objectively evaluate one or more GEN AI solutions or use cases to help an organization to make informed decisions about whether the solution should be pursued or not. In addition, the system described herein may provide recommendations on how to improve the GEN AI solutions making them more secure and safe for implementation.

In the past, when a division or a sub-organization of an organization wants to have an AI tool developed, or wants to conduct a project which may involve GEN AI based technology, a member of the organization may need to provide answers to certain questions about what data may be used to train and deploy the AI tool. The data needed to train the model may include trade secret or confidential data to the organization. Accordingly, if the tool is developed or a project is conducted without evaluating various use case components associated with developing the tool or conducting the project using GEN AI, it may lead to a data compromising event for the organization and/or the value of the tool may not outweigh the risk associated with deploying the tool. Accordingly, in the example embodiments described herein, prior to developing the generative AI solution, an objective evaluation of the GEN AI solution is performed. By way of a non-limiting example, the objective evaluation of the GEN AI solution may be performed based on user inputs to a questionnaire for the specific use case (or GEN AI solution, such as, a tool to be developed, a project to be conducted, a business proposal, a search project, etc.). The questionnaire may include one or more multiple-choice type questions based on a plurality of use case components. By way of a non-limiting example, a subset of the plurality of use case components that are considered may be fixed components such that they are always considered by the evaluation system. Additionally, or alternatively, the plurality of use case components may further include another subset of use case components that is dynamically determined based at least in part on the details of the use case, the user submitting the use case, and/or the sub organization associated with the use case.

In some embodiments, a use score may be generated based upon the plurality of use case components including a data type, a decision type, a type of personal information, a customer type, an entity managing an application server, and/or a location of the application server. The data type component may identify or corresponds with a type of data to be used, for example, as prompts for the use case or the GEN AI solution. By way of a non-limiting example, the data type may suggest whether the data used for inputting or building the tool is fabricated data, public data, data identified for internal use, confidential data, and/or trade secret. A different sub-score value may be assigned for the data type component based upon the data type. In some examples, the sub-score value assigned to the fabricated data or public data may be 2, the sub-score value assigned to the data identified for internal user may be 4, the sub-score value assigned to the confidential data may be 6, and the sub-score value assigned to the trade secret may be 8.

The decision type may identify whether the use case or GEN AI solution involves a discovery, further decision support, and/or an automated action. In some examples, the discovery type, the further decision support type, and automated action type may have respective sub-score values of 0.5, 1, and 2. The type of personal information may be a Boolean identifying whether the use case or GEN AI solution requires inputs that include or uses personal information or not. In some examples, a sub-score value of 2 may be assigned to the personal information and a sub-score value of 1 may be assigned to non-personal information. The customer type may identify whether the use case or GEN AI solution is being submitted based upon a request from an internal customer (or for someone within the organization) or an external customer (or for someone outside of the organization). When the use case or GEN AI solution is developed by another organization or another entity or the GEN AI solution is to be used by an outside party, then the customer type may be set to the external customer. The sub-score value may be assigned to 2 for the external customer and the sub-score value of 1 may be assigned for the internal customer. When the application server is located on the premises of the organization, or being managed by the organization, then the sub-score value of 1 may be considered for this use case component, and when the application server is not located on the premises of the organization, or not being managed by the organization, then the sub-score value of 3 may be considered for this use case component.

In some embodiments, an overall use score value may be calculated by multiplying (or combining in some other mathematical formulation) a respective sub-score value for each use case component of the plurality of use case components. Additionally, or alternatively, a different weight factor may be assigned to the respective sub-score value of each use case component of the plurality of use case components. In some embodiments, and by way of a non-limiting example, the weight factor may be assigned based upon severity or probability of a data compromising event occurring corresponding to each sub-component of a use case component of the plurality of use case components. In some embodiments, a value of a sub-score may be determined based at least in part upon different categories including value, risk, repeatability, technical complexity and prioritization. Accordingly, each different sub-score may indicate a relationship between the use case component of the plurality of use case components and the corresponding category of evaluation.

In some embodiments, the user may submit the use case or GEN AI solution using a graphical user interface (GUI) of a frontend application executing on the user's user device or user equipment. The frontend application may be a web browser-based application, or a mobile application, etc. Using the GUI, the user may provide details of the specific use case or GEN AI solution to the evaluation system. By way of a non-limiting example, details of the use case or GEN AI solution may be provided as textual input. Additionally, or alternatively, the user may select pre-populated text boxes to provide details of the specific use case or GEN AI solution. Based at least in part upon the details of the use case or GEN AI solution, a template (or a questionnaire) may be generated and displayed on the GUI. The template may include one or more options (or sub-components) for each use case component of the plurality of use case components for the user to select and provide as his or her inputs. A respective value for each option (or sub-component) of a use case component may be preconfigured. The respective value for each option of a use case component is referenced herein as a sub-score. In some embodiments, the preconfigured respective value for each option of the use case component may not be displayed to the user on the GUI.

In some embodiments, whether the use case submitted by the user is based upon generative AI may be indicated by the user on the GUI. Alternatively, or additionally, whether the use case submitted by the user is based upon GEN AI may be determined by an algorithm (such as a classical machine learning algorithm) using the user provided details of the use case. By way of a non-limiting example, an amount of the details and/or a structure of the details provided by the user for the use case may be analyzed using natural language processing technologies.

In some embodiments, the overall use score value may be fed into a prioritization algorithm, which may be configured to generate recommendations on how to move forward with each use case among a plurality of use cases. Additionally, or alternatively, the embodiments described herein may free up risk personnel of the organization and make the process more efficient for internal customers to review GEN AI based use cases while improving efficiency of resource allocation with better performance and reduced expense cost and accepting GEN AI use cases based upon pros and cons associated with each GEN AI use case.

Various embodiments are described herein using the figures discussed below.

### Exemplary Process of Evaluating GEN AI Solutions Using the GEN AI Evaluation System

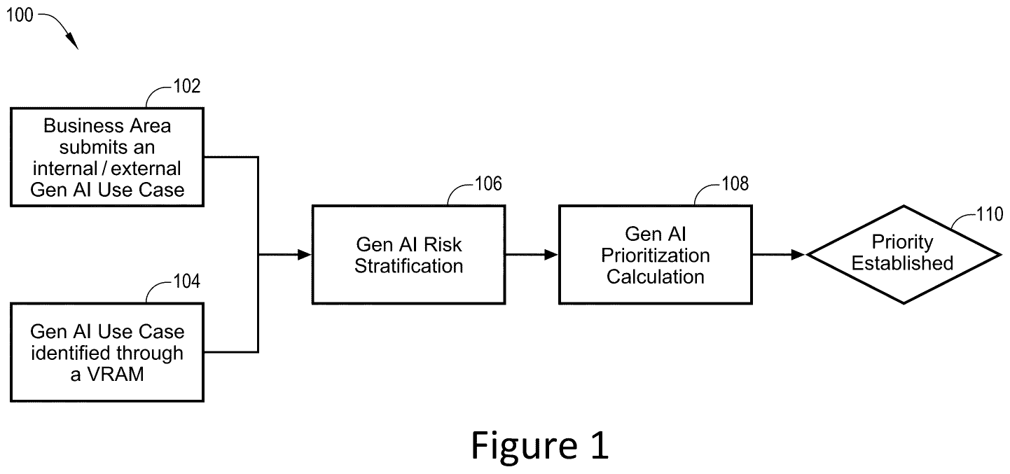

FIG. 1 depicts an exemplary process 100 for objectively evaluating and prioritizing GEN AI use cases or GEN AI solutions using the GEN AI evaluation system described herein. As shown in FIG. 1, a user may submit 102 a use case using a GUI of a frontend application executing on the user's user device or user equipment. In some embodiments, and by way of a non-limiting example, the user may be a sub-organization or a business entity. The frontend application may be a web browser-based application, or a mobile application. Using the GUI, the user may provide details of the specific use case. By way of a non-limiting example, details of the use case may be provided as textual input. In some embodiments, whether the use case submitted by the user is based upon GEN AI may be indicated by the user on the GUI while the user submits 102 the use case.

Alternatively, or additionally, whether the use case submitted by the user is based upon GEN AI may be determined 104 by an algorithm (such as a classical machine learning algorithm) using the user provided details of the use case. By way of a non-limiting example, an amount of the details and/or a structure of the details provided by the user for use case may be analyzed using language processing technologies (e.g., natural language processing algorithms). When the user has provided sparse details for the use case, and/or the structure of the details indicates sentences in a question form, the system may use the language processing tools to extract key words from the inputted sentences or may generate additional details for the use case based on historical data of prior use cases in order to determine 104 that the use case submitted by the user is based upon GEN AI. The machine learning algorithm may be configured to analyze the inputted data, generate supplemental data, and otherwise determine what the use case involves and whether GEN AI will be need to implement the uses case.

When it is determined by the GEN AI evaluation system that the use case submitted by the user is a GEN AI use case, based at least in part upon the details of the use case, a dynamically created template (or a questionnaire) may be generated and displayed on the GUI for stratifying 106 the user submitted GEN AI use case among other GEN AI use cases. The template may include one or more options (or sub-components) for each use case component of a plurality of use case components for the user to select and provide as his or her inputs. A respective value for each option (or sub-component) of a use case component may be preconfigured. The respective value for each option of a use case component is referenced herein as a sub-score. In some embodiments, the preconfigured respective value for each option of the use case component may not be displayed to the user on the GUI. These values may be stored in memory and retrieved using a memory lookup.

In some embodiments, by way of a non-limiting example, a subset of the plurality of use case components may be fixed (or default) use case components. Additionally, or alternatively, the plurality of use case components may further include another subset of use case components that may be dynamically determined based at least in part on the details of the use case, the user submitting the use case, and/or the business entity or a sub organization submitting, or associated with, the use case.

In some embodiments, the stratifying 106 of the user submitted GEN AI use case among other GEN AI use cases includes generating a use score, which may also be referenced herein as an overall use score, based upon the plurality of use case components that include data type, decision type, type of personal information, customer type, entity managing the application server, and/or a location of the application server. The data type use case component may identify, or corresponds with, a type of data to be used, for example, as prompts for the use case. By way of a non-limiting example, the data type may suggest whether the data used for inputting or building the tool is fabricated data, public data, data identified for internal use, confidential data, and/or trade secret. A different sub-score value may be assigned for the data type component based upon the data type. In some examples, the sub-score value assigned to the fabricated data or public data may be 2, the sub-score value assigned to the data identified for internal user may be 4, the sub-score value assigned to the confidential data may be 6, and the sub-score value assigned to the trade secret may be 8.

The decision type component may identify whether the use case or GEN AI solution involves a discovery, further decision support, and/or an automated action. In some examples, the discovery type, further decision support type, and automated action type may have respective sub-score values of 0.5, 1, and 2. The type of personal information may be a Boolean identifying whether the use case or GEN AI solution requires inputs that include or uses personal information or not. In some examples, a sub-score value of 2 may be assigned to the personal information and a sub-score value of 1 may be assigned to the non-personal information. The customer type may identify whether the use case or GEN AI solution is being submitted based upon a request from an internal customer (or for someone within the organization) or an external customer (or for someone outside of the organization). The sub-score value may be assigned to 2 for the external customer and the sub-score value of 1 may be assigned for the internal customer. When the application server is located on the premises of the organization, or being managed by the organization, then the sub-score value of 1 may be considered for this use case component, and when the application server is not located on the premises of the organization, or not being managed by the organization, then the sub-score value of 3 may be considered for this use case component.

In some embodiments, a use score value (or an overall use score value) may be calculated by multiplying (or combining in some other mathematical formulation) a respective sub-score value for each use case component of the plurality of use case components. Additionally, or alternatively, a different weight factor may be assigned to the respective sub-score value of each use case component of the plurality of use case components. In some embodiments, and by way of a non-limiting example, the weight factor may be assigned based upon severity or probability of occurring a data compromising event corresponding to each sub-component of a use case component of the plurality of use case components. In some embodiments, additionally, or alternatively, a value of a sub-score may be determined based at least in part upon different categories including value, risk, repeatability, technical complexity and prioritization. Accordingly, each different sub-score may indicate a relationship between the use case component of the plurality of use case components and the corresponding category of evaluation.

In some embodiments, prioritization of the GEN AI use cases may be determined 108 based upon the overall use score calculated for each GEN AI use case corresponding to the plurality of use case components, and other aspects such as technical complexity, repeatability, and/or prioritization. The determined prioritization of a GEN AI use case may be used for establishing 110 a respective priority for each GEN AI use case of different GEN AI use cases for generating recommendations on how to move forward with each GEN AI use case among a plurality of GEN AI use cases.

In some embodiments, determining 108 prioritization of GEN AI use cases and/or establishing 110 a respective priority for each GEN AI use case may use a prioritization algorithm, which may be used to generate recommendations on how to move forward with each GEN AI use case. Accordingly, the process 100 described herein may free up risk personnel of the organization and make the process more efficient for internal customers to review GEN AI based use cases while improving efficiency of resource allocation with better performance and reduced expense cost and accepting GEN AI use cases based upon pros and cons associated with each GEN AI use case. In some embodiments, the GEN AI evaluation system may also be configured to identify for the user what confidential information may be used in the use case and how it may be exposed if the use case is deployed. By so doing, the system is better able to evaluate the risks associated with the use case and may be able to recommend how the use case may be altered to reduce the risk of data compromise.

### Exemplary User Device or a User Equipment

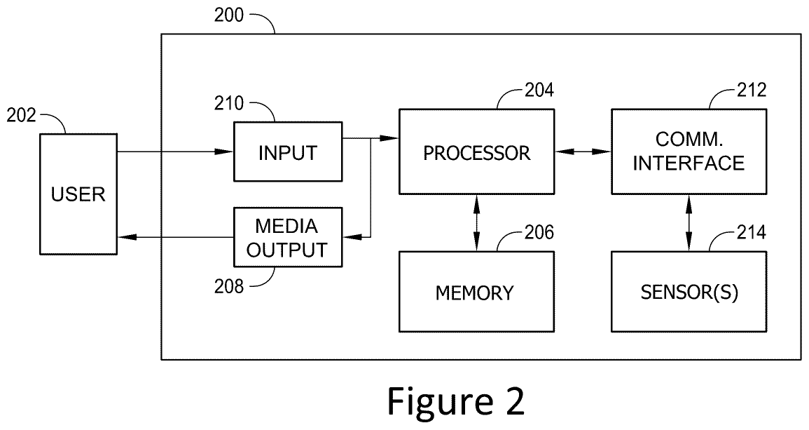

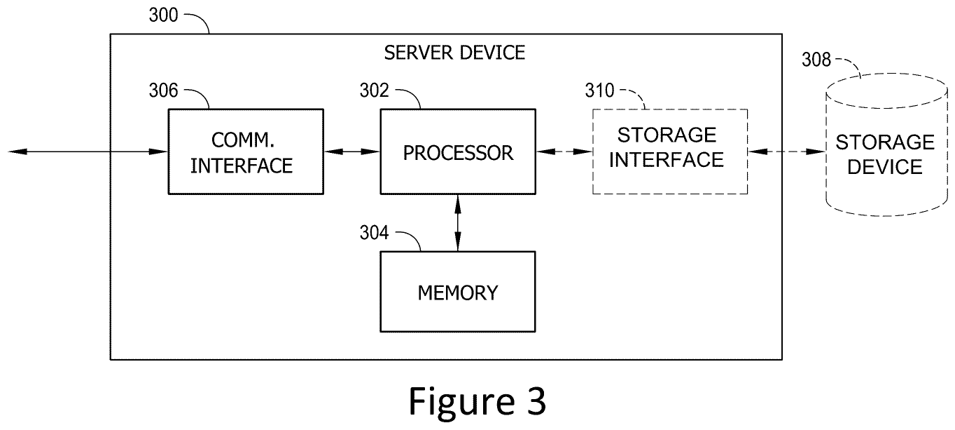

FIG. 2 depicts an exemplary configuration of a user device or user equipment 200 for use with the process 100 shown in FIG. 1, in accordance with one embodiment of the present disclosure. The user equipment 200 may include, but is not limited to, a smart phone, a tablet, a laptop, an electronic device equipped with at least one transceiver to communicate with a server described herein using FIG. 3. Additionally, or alternatively, the user equipment 200 may be, for example, a mobile device, smart home controller, a smart watch, smart contact lenses, augmented reality (AR) glasses, virtual reality (VR) headset, mixed or extended reality headset or glasses, wearables, voice or chat bot, an IOT device, other input device, and/or other electronic or electrical devices.

The user equipment or user device 200 may include a processor 204 for executing instructions. In some embodiments, executable instructions may be stored in a memory 206. Processor 204 may include one or more processing units (e.g., in a multi-core configuration). Memory 206 may be any device allowing information such as executable instructions and/or transaction data to be stored and retrieved. Memory 206 may include one or more computer readable media.

The user equipment 200 may also include at least one media output component 208 for presenting information to a user 202. Media output component 208 may be any component capable of conveying information to the user 202. In some embodiments, media output component 208 may include an output adapter (not shown) such as a video adapter and/or an audio adapter. An output adapter may be operatively coupled to processor 204 and operatively couplable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 208 may be configured to present a graphical user interface (e.g., a web browser and/or a client application) to the user 202. A graphical user interface may include, for example, an interface for viewing and/or entering prompts and data. In some embodiments, the user equipment 200 may include an input 210 for receiving input from the user 202. The user 202 may use input 210 to, without limitation, provide user input.

Input device 210 may include, for example, a keyboard, a pointing device, a mouse, a stylus, a touch sensitive panel (e.g., a touch pad or a touch screen), a biometric input device, at least one vision sensor (e.g., a camera or a video camera), and/or an audio input device such as a microphone. A single component such as a touch screen display may function as both an output device of media output component 208 and input device 210.

The user equipment 200 may also include a communication interface 212, communicatively coupled to a backend system, an application server, and/or a server described herein using FIG. 3. Communication interface 212 may include, for example, a wired or wireless network adapter and/or a wireless data transceiver.

Stored in memory 206 are, for example, computer readable instructions for providing a user interface to the user 202 via media output component 208 and, optionally, receiving and processing input from input 210. A user interface may include, among other possibilities, a web browser and/or a client application. Web browsers enable users, such as the user 202, to display and interact with media and other information typically embedded on a web page or a website from the backend system. A client application (e.g., a frontend application executing on the user device 200) may allow the user 202 to interact with, for example, the backend system.

In some embodiments, the user equipment 200 may include one or more sensors 214. By way of a non-limiting example, the one or more sensors 214 may include, but is not limited to, a gyroscope, an accelerometer, a position detector, a temperature sensor, a lux sensor (or a light level sensor), a water level sensor, an air composition sensor, an image sensor, a voice/sound sensor, a pressure sensor, a humidity sensor, an accelerometer, an infrared sensor, a vibration sensor, and/or an ultrasonic sensor.

In some embodiments, generative artificial intelligence (AI) models (also referred to as generative machine learning (ML) models) may be utilized with the present embodiments, and the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by and/or used in conjunction with reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text, or textual output, visual or graphical output, output for use with speakers and/or display screens, and/or other types of output for user and/or other computer or bot consumption.

### Exemplary Application Server

FIG. 3 depicts an exemplary configuration of an application server 300 of a backend system, in accordance with one embodiment of the present disclosure. Application server 300 may be configured to perform various operations, as described herein, from the backend system perspective. Application server 300 may include the GEN AI evaluation computing device and be part of the GEN AI evaluation system. Processor 302 may include one or more processing units (e.g., in a multi-core configuration). Processor 302 may be operatively coupled to a communication interface 306 such that the application server 300 is capable of communicating with a remote device, such as another application server 300, the user device 200, for example, via a network using wireless communication or data transmission over one or more radio links or digital communication channels. For example, communication interface 306 may receive data, e.g., image, video, and/or text. By way of a non-limiting example, the application server 300 may be a server which may receive details of a use case submitted by a user and may transmit a template of a questionnaire back to the user for stratifying the user submitted use case, as described herein.

Processor 302 may also be operatively coupled to a storage device 308. Storage device 308 may be any computer-operated hardware suitable for storing and/or retrieving data, such as, but not limited to, data associated with historic databases. In some embodiments, storage device 308 may be integrated in the application server 300. For example, the application server 300 may include one or more hard disk drives as storage device 308.

In other embodiments, storage device 308 may be external to host computing device 300 and may be accessed by a plurality of user devices 200. For example, storage device 308 may include a storage area network (SAN), a network attached storage (NAS) system, and/or multiple storage units such as hard disks and/or solid-state disks in a redundant array of inexpensive disks (RAID) configuration.

In some embodiments, processor 302 may be operatively coupled to storage device 308 via a storage interface 310. Storage interface 310 may be any component capable of providing processor 302 with access to storage device 308. Storage interface 310 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 302 with access to storage device 308.

Processor 302 may execute computer-executable instructions for implementing aspects of the disclosure. In some embodiments, the processor 302 may be transformed into a special purpose microprocessor by executing computer-executable instructions or by otherwise being programmed. In some embodiments, and by way of a non-limiting example, the memory 304 may include instructions to perform specific operations, as described herein.

### Exemplary Computer-Implemented Method

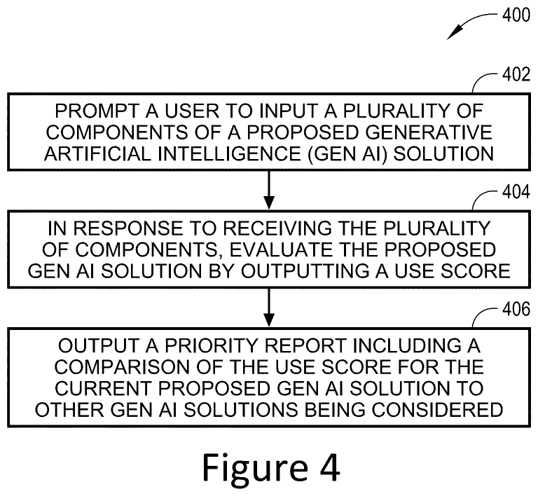

FIG. 4 depicts a flow-chart 400 of example computer-implemented method operations performed by server 300 as part of the GEN AI evaluation system. The server 300 being communicatively coupled with the at least one user device 200, via a network, as described herein. The network may be a Wi-Fi network, a local area network (LAN), a wide area network (WAN), and/or a wireline or wireless network, etc. The method operations performed, for example, by the server 300 may include prompting 402 a user to provide input for a plurality of components, which are also referenced herein as a plurality of use case components, of a proposed GEN AI solution into the GEN AI evaluation system. By way of a non-limiting example, the user may provide input to a template requesting user input for the plurality of components. The template may be caused to be displayed on a user computing device of the user. The plurality of components of the template may be generated based upon use case details of the proposed GEN AI solution. By way of a non-limiting example, a subset of the plurality of components of the template may be preconfigured or fixed, and/or a subset of the plurality of components of the template may be dynamically determined based upon the proposed GEN AI solution. Accordingly, the template displayed on the user computing device may prompt the user to provide details of the GEN AI solution including use case details.

The method operations described in flow-chart 400 may further include evaluating 404 the proposed GEN AI solution by outputting a use score. The use score may represent an overall value of deploying the proposed GEN AI solution. By way of a non-limiting example, the overall value may include certain components that relate to unwanted events such as a data compromising event, or a probability of a data compromising event occurring. In some embodiments, language processing tools (e.g., natural language processing algorithms) may be used to analyze the details inputted for the proposed GEN AI solution when outputting the use score.

Further, the method operations described in the flow-chart 400 may include outputting 406 a priority report including a comparison of the use score for the current proposed GEN AI solution to other GEN AI solutions being considered. The plurality of components of the proposed GEN AI solution may include, but not limited to, a data type description, a personal information component, a customer type component, a server location component, a server managing entity, or a decision type. A different sub-score based upon a respective value of each component of the plurality of components may be assigned when evaluating the proposed GEN AI solution. Each different sub-score may be assigned for different categories including value, risk, repeatability, technical complexity and prioritization. Additionally, or alternatively, each different sub-score may indicate a relationship between the component of the plurality of components and the corresponding category of evaluation.

### Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

In some embodiments, the GEN AI system configured to implement process 100 for objectively evaluating and prioritizing GEN AI use cases is further configured to implement machine learning, such that the GEN AI computer system “learns” to analyze, organize, and/or process data without being explicitly programmed. Machine learning may be implemented through machine learning methods and algorithms (“ML methods and algorithms”). In one exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images. ML outputs may include, but are not limited to identified objects, items classifications, and/or other data extracted from the images. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of images with known characteristics or features or with a large sample of other data with known characteristics or features. Such information may include, for example, information associated with a plurality of images and/or other data of a plurality of different objects, items, and/or property including appliances and/or other systems.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments and may the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text or textual output, visual or graphical output, output for use with speakers and/or display screens, and/or other types of output for user and/or other computer or bot consumption.

Based upon these analyses, the processing element may learn how to identify characteristics and patterns that may then be applied to analyzing and classifying objects. The processing element may also learn how to identify attributes of different objects in different lighting. This information may be used to determine which classification models to use and which classifications to provide.

### Additional Exemplary Embodiments

Additional exemplary embodiments of the systems and methods described herein are provided herein. For example, in one embodiment, a computing device may include at least one memory and at least one processor in communication with the at least one memory. The at least one processor may be programmed to: (i) prompt a user to input a plurality of components of a proposed generative artificial intelligence (GEN AI) solution by causing to be displayed on a user computing device a template requesting the plurality of components; (ii) in response to receiving the plurality of components, evaluate the proposed GEN AI solution by outputting a use score, wherein the use score represents an overall value of deploying the GEN AI solution, the overall value including a data compromising event; and (iii) output a priority report including a comparison of the use score for the current proposed GEN AI solution to other GEN AI solutions being considered.

Further, the computing device in accordance with the preceding aspects may further include wherein the template displayed on the user computing device prompts the user to provide details of the GEN AI solution including use case details.

Further, the computing device in accordance with any of the preceding aspects may further include the at least one processor being further programmed to use language processing tools to analyze the details inputted for the GEN AI solution when outputting the use score.

Additionally, or alternatively, the computing device in accordance with any of the preceding aspects may further include wherein the plurality of components of the proposed GEN AI solution includes a data type description for data to be used with the proposed GEN AI solution, wherein the data type description include at least fabricated or public data, internal use data, confidential data, or trade secret data.

In addition, the computing device in accordance with any of the preceding aspects may further include wherein each data type is assigned a different sub-score when evaluating the proposed GEN AI solution, each sub-score of the data type is assigned for different categories including value, risk, repeatability, technical complexity and prioritization, wherein each sub-score of the data type indicates a relationship between the data type and the corresponding category of evaluation.

Additionally, or alternatively, the computing device in accordance with any of the preceding aspects may further include wherein the plurality of components of the proposed GEN AI solution includes a personal information component for data to be used with the proposed GEN AI solution, wherein the personal information component includes at least YES personal information is being used or NO personal information is not being used.

In addition, the computing device in accordance with any of the preceding aspects may further include wherein each personal information component is assigned a different sub-score when evaluating the proposed GEN AI solution, each sub-score of the personal information component is assigned for different categories including value, risk, repeatability, technical complexity and prioritization, wherein each sub-score of the personal information component indicates a relationship between the personal information component and the corresponding category of evaluation.

Additionally, or alternatively, the computing device in accordance with any of the preceding aspects may further include wherein the plurality of components of the proposed GEN AI solution includes a decision type component for data to be used with the proposed GEN AI solution, wherein the decision type component includes at least discovery, decision support, or automated action.

In addition, the computing device in accordance with any of the preceding aspects may further include wherein each decision type component is assigned a different sub-score when evaluating the proposed GEN AI solution, each sub-score of the decision type component is assigned for different categories including value, risk, repeatability, technical complexity and prioritization, wherein each sub-score of the decision type component indicates a relationship between the decision type component and the corresponding category of evaluation.

Additionally, or alternatively, the computing device in accordance with any of the preceding aspects may further include wherein the plurality of components of the proposed GEN AI solution includes a customer type component for data to be used with the proposed GEN AI solution, wherein the customer type component includes at least an internal customer, or an external customer.

In addition, the computing device in accordance with any of the preceding aspects may further include wherein each customer type component is assigned a different sub-score when evaluating the proposed GEN AI solution, each sub-score of the customer type component is assigned for different categories including value, risk, repeatability, technical complexity and prioritization, wherein each sub-score of the customer type component indicates a relationship between the customer type component and the corresponding category of evaluation.

Additionally, or alternatively, the computing device in accordance with any of the preceding aspects may further include wherein the plurality of components of the proposed GEN AI solution includes a server location component for data to be used with the proposed GEN AI solution, wherein the server location component includes at least a local location, or a remote location.

In addition, the computing device in accordance with any of the preceding aspects may further include wherein each server location component is assigned a different sub-score when evaluating the proposed GEN AI solution, each sub-score of the server location component is assigned for different categories including value, risk, repeatability, technical complexity and prioritization, wherein each sub-score of the server location component indicates a relationship between the server location component and the corresponding category of evaluation.

Additionally, or alternatively, the computing device in accordance with any of the preceding aspects may further include wherein the plurality of components of the proposed GEN AI solution includes a server managing entity for data to be used with the proposed GEN AI solution, wherein the server managing entity includes at least a self-entity, or another entity.

In addition, the computing device in accordance with any of the preceding aspects may further include wherein each server managing entity is assigned a different sub-score when evaluating the proposed GEN AI solution, each sub-score of the server managing entity is assigned for different categories including value, risk, repeatability, technical complexity and prioritization, wherein each sub-score of the server managing entity component indicates a relationship between the server managing entity and the corresponding category of evaluation.

In another embodiment, a computer-implemented method is disclosed. The computer-implemented method, which may be implemented using one or more processors, may include: (i) prompting a user to input a plurality of components of a proposed generative artificial intelligence (GEN AI) solution by causing to be displayed on a user computing device a template requesting the plurality of components; (ii) in response to receiving the plurality of components, evaluating the proposed GEN AI solution by outputting a use score, wherein the use score represents an overall value of deploying the GEN AI solution, the overall value including a data compromising event; and (iii) outputting a priority report including a comparison of the use score for the current proposed GEN AI solution to other GEN AI solutions being considered.

Further, the computer-implemented method in accordance with the preceding operations may further include wherein the template displayed on the user computing device prompts the user to provide details of the GEN AI solution including use case details.

Additionally, or alternatively, the computer-implemented method in accordance with any of the preceding operations may further include using language processing tools to analyze the details inputted for the GEN AI solution when outputting the use score.

Further, the computer-implemented method in accordance with any of the preceding operations may further include wherein the plurality of components of the proposed GEN AI solution includes a data type description for data to be used with the proposed GEN AI solution, wherein the data type description includes at least fabricated or public data, internal use data, confidential data, or trade secret data.

Additionally, or alternatively, the computer-implemented method in accordance with any of the preceding operations may further include assigning each data type a different sub-score when evaluating the proposed GEN AI solution, each sub-score of the data type is assigned for different categories including value, risk, repeatability, technical complexity and prioritization, wherein each sub-score of the data type indicates a relationship between the data type and the corresponding category of evaluation.

Further, the computer-implemented method in accordance with any of the preceding operations may further include wherein the plurality of components of the proposed GEN AI solution includes a personal information component for data to be used with the proposed GEN AI solution, wherein the personal information component includes at least YES personal information is being used or NO personal information is not being used.

Additionally, or alternatively, the computer-implemented method in accordance with any of the preceding operations may further include assigning each personal information component a different sub-score when evaluating the proposed GEN AI solution, each sub-score of the personal information component is assigned for different categories including value, risk, repeatability, technical complexity and prioritization, wherein each sub-score of the personal information component indicates a relationship between the personal information component and the corresponding category of evaluation.

Further, the computer-implemented method in accordance with any of the preceding operations may further include wherein the plurality of components of the proposed GEN AI solution includes a decision type component for data to be used with the proposed GEN AI solution, wherein the decision type component includes at least discovery, decision support, or automated action.

Additionally, or alternatively, the computer-implemented method in accordance with any of the preceding operations may further include assigning each decision type component a different sub-score when evaluating the proposed GEN AI solution, each sub-score of the decision type component is assigned for different categories including value, risk, repeatability, technical complexity and prioritization, wherein each sub-score of the decision type component indicates a relationship between the decision type component and the corresponding category of evaluation.

Further, the computer-implemented method in accordance with any of the preceding operations may further include wherein the plurality of components of the proposed GEN AI solution includes a customer type component for data to be used with the proposed GEN AI solution, wherein the customer type component includes at least an internal customer, or an external customer.

Additionally, or alternatively, the computer-implemented method in accordance with any of the preceding operations may further include assigning each customer type component a different sub-score when evaluating the proposed GEN AI solution, each sub-score of the customer type component is assigned for different categories including value, risk, repeatability, technical complexity and prioritization, wherein each sub-score of the customer type component indicates a relationship between the customer type component and the corresponding category of evaluation.

Further, the computer-implemented method in accordance with any of the preceding operations may further include wherein the plurality of components of the proposed GEN AI solution includes a server location component for data to be used with the proposed GEN AI solution, wherein the server location component includes at least a local location, or a remote location.

Additionally, or alternatively, the computer-implemented method in accordance with any of the preceding operations may further include assigning each server location component a different sub-score when evaluating the proposed GEN AI solution, each sub-score of the server location component is assigned for different categories including value, risk, repeatability, technical complexity and prioritization, wherein each sub-score of the server location component indicates a relationship between the server location component and the corresponding category of evaluation.

Further, the computer-implemented method in accordance with any of the preceding operations may further include wherein the plurality of components of the proposed GEN AI solution includes a server managing entity for data to be used with the proposed GEN AI solution, wherein the server managing entity includes at least a self-entity, or another entity.

Additionally, or alternatively, the computer-implemented method in accordance with any of the preceding operations may further include assigning each server managing entity a different sub-score when evaluating the proposed GEN AI solution, each sub-score of the server managing entity is assigned for different categories including value, risk, repeatability, technical complexity and prioritization, wherein each sub-score of the server managing entity component indicates a relationship between the server managing entity and the corresponding category of evaluation.

Additionally, or alternatively, the computer-implemented method in accordance with any of the preceding operations may further include the plurality of components of the proposed GEN AI solution including a personal information component for data to be used with the proposed GEN AI solution, and the personal information component including at least YES personal information is being used or NO personal information is not being used.

Additionally, or alternatively, the computer-implemented method in accordance with any of the preceding operations may further include assigning each personal information component a different sub-score when evaluating the proposed GEN AI solution, each sub-score of the personal information component is assigned for different categories including value, risk, repeatability, technical complexity and prioritization, wherein each sub-score of the personal information component indicates a relationship between the personal information component and the corresponding category of evaluation.

Additionally, or alternatively, the computer-implemented method in accordance with any of the preceding operations may further include the plurality of components of the proposed GEN AI solution including a decision type component for data to be used with the proposed GEN AI solution, and the decision type component including at least discovery, decision support, or automated action.

Additionally, or alternatively, the computer-implemented method in accordance with any of the preceding operations may further include assigning each decision type component a different sub-score when evaluating the proposed GEN AI solution, each sub-score of the decision type component is assigned for different categories including value, risk, repeatability, technical complexity and prioritization, wherein each sub-score of the decision type component indicates a relationship between the decision type component and the corresponding category of evaluation.

Additionally, or alternatively, the computer-implemented method in accordance with any of the preceding operations may further include the plurality of components of the proposed GEN AI solution including a customer type component for data to be used with the proposed GEN AI solution, and the customer type component including at least an internal customer, or an external customer.

Additionally, or alternatively, the computer-implemented method in accordance with any of the preceding operations may further include assigning each customer type component a different sub-score when evaluating the proposed GEN AI solution, each sub-score of the customer type component is assigned for different categories including value, risk, repeatability, technical complexity and prioritization, wherein each sub-score of the customer type component indicates a relationship between the customer type component and the corresponding category of evaluation.

Additionally, or alternatively, the computer-implemented method in accordance with any of the preceding operations may further include the plurality of components of the proposed GEN AI solution including a server location component for data to be used with the proposed GEN AI solution, and the server location component including at least a local location, or a remote location.

Additionally, or alternatively, the computer-implemented method in accordance with any of the preceding operations may further include assigning each server location component a different sub-score when evaluating the proposed GEN AI solution, each sub-score of the server location component is assigned for different categories including value, risk, repeatability, technical complexity and prioritization, wherein each sub-score of the server location component indicates a relationship between the server location component and the corresponding category of evaluation.

Additionally, or alternatively, the computer-implemented method in accordance with any of the preceding operations may further include the plurality of components of the proposed GEN AI solution including a server managing entity for data to be used with the proposed GEN AI solution, and the server managing entity including at least a self-entity, or another entity.

Additionally, or alternatively, the computer-implemented method in accordance with any of the preceding operations may further include assigning each server managing entity a different sub-score when evaluating the proposed GEN AI solution, each sub-score of the server managing entity is assigned for different categories including value, risk, repeatability, technical complexity and prioritization, wherein each sub-score of the server managing entity component indicates a relationship between the server managing entity and the corresponding category of evaluation.

In one aspect, a non-transitory computer-readable storage media having computer-executable instructions embodied thereon may be provided. When executed by at least one processor of a data processing computer device, the computer-executable instructions may cause the at least one processor to: (i) prompt a user to input a plurality of components of a proposed generative artificial intelligence (GEN AI) solution by causing to be displayed on a user computing device a template requesting the plurality of components; (ii) in response to receiving the plurality of components, evaluate the proposed GEN AI solution by outputting a use score, wherein the use score represents an overall value of deploying the GEN AI solution, the overall value including a data compromising event; and (iii) output a priority report including a comparison of the use score for the current proposed GEN AI solution to other GEN AI solutions being considered.

Further, the non-transitory computer-readable storage media with instructions embodied thereon in accordance with the preceding aspects may further include wherein the template displayed on the user computing device prompts the user to provide details of the GEN AI solution including use case details.

Further, the non-transitory computer-readable storage media with instructions embodied thereon in accordance with the preceding aspects may further cause the at least one processor to use language processing tools to analyze the details inputted for the GEN AI solution when outputting the use score.

Additionally, or alternatively, the non-transitory computer-readable storage media with instructions embodied thereon in accordance with the preceding aspects may further include wherein the plurality of components of the proposed GEN AI solution includes a data type description, a personal information component, a customer type component, a server location component, a server managing entity, or a decision type.

In addition, the non-transitory computer-readable storage media with instructions embodied thereon in accordance with the preceding aspects may further cause the at least one processor to assign a different sub-score based upon a respective value of each component of the plurality of components when evaluating the proposed GEN AI solution, each different sub-score is assigned for different categories including value, risk, repeatability, technical complexity and prioritization, wherein each different sub-score indicates a relationship between the component of the plurality of components and the corresponding category of evaluation.

Additionally, or alternatively, the non-transitory computer-readable storage media with instructions embodied thereon in accordance with the preceding aspects may further include in response to execution by at least one processor, cause the at least one processor to: prompt a user to input a plurality of components of a proposed generative artificial intelligence (GEN AI) solution by causing to be displayed on a user computing device a template requesting the plurality of components; in response to receiving the plurality of components, evaluate the proposed GEN AI solution by outputting a use score, wherein the use score represents an overall value of deploying the GEN AI solution, the overall value including a data compromising event; and output a priority report including a comparison of the use score for the current proposed GEN AI solution to other GEN AI solutions being considered.

Additionally, or alternatively, the non-transitory computer-readable storage media with instructions embodied thereon in accordance with the preceding aspects may further include the template displayed on the user computing device prompts the user to provide details of the GEN AI solution including use case details.

Additionally, or alternatively, the non-transitory computer-readable storage media with instructions embodied thereon in accordance with the preceding aspects may further include instructions further causing the at least one processor to use language processing tools to analyze the details inputted for the GEN AI solution when outputting the use score.

Additionally, or alternatively, the non-transitory computer-readable storage media with instructions embodied thereon in accordance with the preceding aspects may further include the plurality of components of the proposed GEN AI solution including a data type description, a personal information component, a customer type component, a server location component, a server managing entity, or a decision type.

Additionally, or alternatively, the non-transitory computer-readable storage media with instructions embodied thereon in accordance with the preceding aspects may further include instructions further causing the at least one processor to assign a different sub-score based upon a respective value of each component of the plurality of components when evaluating the proposed GEN AI solution, each different sub-score is assigned for different categories including value, risk, repeatability, technical complexity and prioritization, wherein each different sub-score indicates a relationship between the component of the plurality of components and the corresponding category of evaluation.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, e.g., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an exemplary embodiment, the system may be executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computing device for objectively evaluating and prioritizing GEN AI uses cases, the computing device comprising:
at least one memory; and
at least one processor in communication with the at least one memory, wherein the at least one processor is programmed to:
prompt a user to input a plurality of components of a proposed generative artificial intelligence (GEN AI) solution by causing to be displayed on a user computing device a template requesting the plurality of components;
in response to receiving the plurality of components, electronically evaluate the proposed GEN AI solution by outputting a use score, wherein the use score represents an overall value of deploying the GEN AI solution including a likelihood of a data compromising event occurring as a result of the deployment; and
output a priority report including a comparison of the use score for the current proposed GEN AI solution to other GEN AI solutions being considered.

2. The computing device of claim 1, wherein the template displayed on the user computing device prompts the user to provide details of the GEN AI solution including use case details.

3. The computing device of claim 2, wherein the at least one processor is further programmed to use language processing tools to analyze the details inputted for the GEN AI solution when outputting the use score.

4. The computing device of claim 1, wherein the plurality of components of the proposed GEN AI solution includes a data type description for data to be used with the proposed GEN AI solution, wherein the data type description includes at least fabricated or public data, internal use data, confidential data, or trade secret data.

5. The computing device of claim 4, wherein each data type is assigned a different sub-score when evaluating the proposed GEN AI solution, each sub-score of the data type is assigned for different categories including value, risk, repeatability, technical complexity and prioritization, wherein each sub-score of the data type indicates a relationship between the data type and the corresponding category of evaluation.

6. The computing device of claim 1, wherein the plurality of components of the proposed GEN AI solution includes a personal information component for data to be used with the proposed GEN AI solution, wherein the personal information component includes at least YES personal information is being used or NO personal information is not being used.

7. The computing device of claim 6, wherein each personal information component is assigned a different sub-score when evaluating the proposed GEN AI solution, each sub-score of the personal information component is assigned for different categories including value, risk, repeatability, technical complexity and prioritization, wherein each sub-score of the personal information component indicates a relationship between the personal information component and the corresponding category of evaluation.

8. The computing device of claim 1, wherein the plurality of components of the proposed GEN AI solution includes a decision type component for data to be used with the proposed GEN AI solution, wherein the decision type component includes at least discovery, decision support, or automated action.

9. The computing device of claim 8, wherein each decision type component is assigned a different sub-score when evaluating the proposed GEN AI solution, each sub-score of the decision type component is assigned for different categories including value, risk, repeatability, technical complexity and prioritization, wherein each sub-score of the decision type component indicates a relationship between the decision type component and the corresponding category of evaluation.

10. The computing device of claim 1, wherein the plurality of components of the proposed GEN AI solution includes a customer type component for data to be used with the proposed GEN AI solution, wherein the customer type component includes at least an internal customer, or an external customer.

11. The computing device of claim 10, wherein each customer type component is assigned a different sub-score when evaluating the proposed GEN AI solution, each sub-score of the customer type component is assigned for different categories including value, risk, repeatability, technical complexity and prioritization, wherein each sub-score of the customer type component indicates a relationship between the customer type component and the corresponding category of evaluation.

12. The computing device of claim 1, wherein the plurality of components of the proposed GEN AI solution includes a server location component for data to be used with the proposed GEN AI solution, wherein the server location component includes at least a local location, or a remote location.

13. The computing device of claim 12, wherein each server location component is assigned a different sub-score when evaluating the proposed GEN AI solution, each sub-score of the server location component is assigned for different categories including value, risk, repeatability, technical complexity and prioritization, wherein each sub-score of the server location component indicates a relationship between the server location component and the corresponding category of evaluation.

14. The computing device of claim 1, wherein the plurality of components of the proposed GEN AI solution includes a server managing entity for data to be used with the proposed GEN AI solution, wherein the server managing entity includes at least a self-entity, or another entity.

15. The computing device of claim 14, wherein each server managing entity is assigned a different sub-score when evaluating the proposed GEN AI solution, each sub-score of the server managing entity is assigned for different categories including value, risk, repeatability, technical complexity and prioritization, wherein each sub-score of the server managing entity component indicates a relationship between the server managing entity and the corresponding category of evaluation.

16. A computer-implemented method for objectively evaluating and prioritizing GEN AI use cases, the method comprising:
prompting a user to input a plurality of components of a proposed generative artificial intelligence (GEN AI) solution by causing to be displayed on a user computing device a template requesting the plurality of components;
in response to receiving the plurality of components, evaluating the proposed GEN AI solution by outputting a use score, wherein the use score represents an overall value of deploying the GEN AI solution including a likelihood of a data compromising event occurring as a result of the deployment; and
outputting a priority report including a comparison of the use score for the current proposed GEN AI solution to other GEN AI solutions being considered.

17. The computer-implemented method of claim 16, wherein the template displayed on the user computing device prompts the user to provide details of the GEN AI solution including use case details.

18. The computer-implemented method of claim 17, further comprising using language processing tools to analyze the details inputted for the GEN AI solution when outputting the use score.

19. The computer-implemented method of claim 16, wherein the plurality of components of the proposed GEN AI solution includes a data type description for data to be used with the proposed GEN AI solution, wherein the data type description includes at least fabricated or public data, internal use data, confidential data, or trade secret data.

20. At least one non-transitory computer-readable storage medium (CRM) with instructions stored thereon that, in response to execution by at least one processor, cause the at least one processor to:
prompt a user to input a plurality of components of a proposed generative artificial intelligence (GEN AI) solution by causing to be displayed on a user computing device a template requesting the plurality of components;
in response to receiving the plurality of components, evaluate the proposed GEN AI solution by outputting a use score, wherein the use score represents an overall value of deploying the GEN AI solution including a likelihood of a data compromising event occurring as a result of the deployment; and
output a priority report including a comparison of the use score for the current proposed GEN AI solution to other GEN AI solutions being considered.
